(19) United States
(12) Patent Application Publication
(10) Pub. No.: US 2023/0273811 A1
(43) Pub. Date: Aug. 31, 2023

(54) REDUCING SILENT DATA ERRORS USING A HARDWARE MICRO-LOCKSTEP TECHNIQUE

(71) Applicant: Intel Corporation, Santa Clara, CA (US)

(72) Inventors: Michael Mishaeli, Haifa (IL); Eyal Oz-Sinay, Ramat Hasharon (IL); Gavri Berger, Haifa (IL); Gal Ofir, Atzmon (IL); Tomer Weiner, Kefar Hahoresh (IL); Arkady Bramnik, Kiryat Motzkin (IL)

(21) Appl. No.: 17/682,091

(22) Filed: Feb. 28, 2022

(51) Int. Cl. G06F 9/48; G06F 9/22

(52) U.S. Cl. CPC G06F 9/4843; G06F 9/22

(57) ABSTRACT

In one embodiment, an apparatus includes: an instruction fetch circuit to fetch instructions; a decode circuit coupled to the instruction fetch circuit to decode the fetched instructions into micro-operations (pops); a scheduler coupled to the decode circuit to schedule the pops for execution; and an execution circuit coupled to the scheduler, the execution circuit comprising a plurality of execution ports to execute the pops. The scheduler may be configured to: schedule at least some pops of a first type for redundant execution on symmetric execution ports of the plurality of execution ports; and schedule pops of a second type for non-redundant execution on a single execution port of the plurality of execution ports. Other embodiments are described and claimed.

### BACKGROUND

Hardware resiliency within computer systems is foundational to reducing the impact of silent data errors (SDEs) on a large scale datacenter infrastructure. A SDE (also referred to as a silent data corruption (SDC)) is a data corruption that propagates to an interface of a processor or other integrated circuit, without any error being flagged. Inside a processor core, the portion of logic most susceptible to SDE is vector execution circuitry that executes single instruction multiple data (SIMD) instructions. In an Intel® processor, these vector instructions are supported by an Advanced Vector Extensions (AVX) instruction set architecture (ISA) that may be used to speed up data computation/manipulation. In contrast to other portions of logic, where a quality issue can manifest itself as a fault (e.g., page fault, general protection fault, stack segment fault, or machine check fault), erroneous results in the vector execution circuitry will most times result in SDEs. Reducing such errors increases resiliency of various systems incorporating processors or other integrated circuits.

### BRIEF DESCRIPTION OF THE DRAWINGS

FIG. 1 is a block diagram of a processor in accordance with an embodiment.

FIG. 2 is a flow diagram of a method in accordance with an embodiment.

FIG. 3 is a flow diagram of a method in accordance with another embodiment.

FIGS. 4A and 4B illustrate a block diagram of a more specific exemplary in-order core architecture.

FIG. 5 is a block diagram of a processor according to embodiments of the invention.

FIG. 6 is a block diagram of a first more specific exemplary system in accordance with an embodiment of the present invention.

FIG. 7 is a block diagram of a SoC in accordance with an embodiment of the present invention.

FIG. 8 is a block diagram contrasting the use of a software instruction converter to convert binary instructions in a source instruction set to binary instructions in a target instruction set according to embodiments of the invention.

### DETAILED DESCRIPTION

In various embodiments, a processor may be configured to dynamically enable and control a micro-lockstep mechanism that is used to provide sparse silent data error protection. More specifically, in one or more embodiments this micro-lockstep mechanism may be applied to selected execution units of a processor core that may be controlled to redundantly execute, on an instruction or micro-operation (pop) basis, on symmetric execution ports to check whether the results are the same. While embodiments herein apply this lockstep mechanism on a pop basis, understand that in other cases the mechanism may be applied on an instruction basis. Further, while embodiments herein are described with respect to vector execution units that execute vector or other single instruction multiple data (SIMD) instructions, the techniques described herein may be applied to other types of execution units such as integer execution units.

With embodiments of the micro-lockstep mechanism, symmetric execution ports may be leveraged, e.g., at a programmable rigorousness, to dispatch the same pop on two execution ports in tandem and verify that the writeback result of both is the same. With programmable control, a user, via a given software agent, can set a preferred tradeoff between execution bandwidth (performance) and SDE reduction. Stated another way, this tradeoff may be made between performance degradation and checking rigorousness. In contrast to other techniques to protect against SDEs, a micro-lockstep mechanism in accordance with an embodiment may have minimal area cost, and relatively simple implementation/validation. In this way, sparse SDE protection may be provided for particular instructions/pops such as vector instructions (e.g., Intel® AVX ISA instructions).

In contrast, other techniques to provide SDE protection such as residue/parity/error correction coding (ECC) protections are active all the time, and can adversely affect performance, power consumption, and area cost. With one or more embodiments power consumption may remain within power virus limits, since possible execution bandwidth may be replaced with hardware integrity checking without consuming extra power resources.

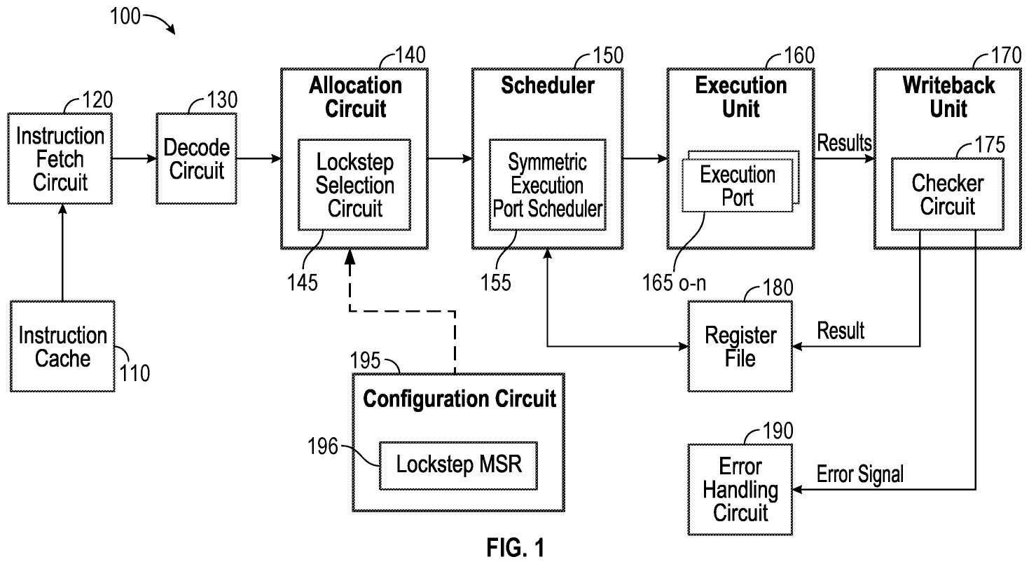

Referring now to FIG. 1, shown is a block diagram of a processor in accordance with an embodiment. As shown in FIG. 1, processor 100 includes various circuitry that may be present within a given core or other processing unit of the processor. Understand of course that additional circuitry, including multiple cores, interface circuitry, memory controller circuitry, accelerator circuitry, cache memories and so forth may be present.

In FIG. 1, a pipeline is illustrated in which instructions are provided to an instruction fetch circuit 120 from an instruction cache 110 or other location. Fetched instructions in turn are provided to a decode circuit 130, where they may be decoded into one or more pops. The resulting pops are then provided to an allocation circuit 140.

As shown in FIG. 1, allocation circuit 140 includes a lockstep selection circuit 145. In general, allocation circuit 140 may be configured to allocate resources for instruction execution, including identifying storage locations (e.g., registers or memory) from which source operands may be obtained and destination operands may be directed, along with an identification of the target execution units.

In embodiments, allocation circuit 140 may include lockstep selection circuit 145, which may be configured to indicate whether a given pop is to be redundantly executed. As will be described herein, this determination may be based on programming of the lockstep mechanism. The programming may wholly enable or disable the mechanism, or partially enable the mechanism for selected pops. In embodiments described herein, the lockstep mechanism is described for use with vector execution circuitry. In other implementations it is possible to apply the lockstep techniques described herein to other execution units. In such implementations, lockstep selection circuit 145 may further identify for which execution units redundant execution is to occur.

Still referring to FIG. 1, allocated pops are passed from allocation circuit 140 to a scheduler 150. In embodiments, scheduler 150 may schedule pops for execution on a given execution unit when all needed source operands are available. In some embodiments, scheduler 150 may be implemented at least in part via a reservation station. In other cases, a scheduler circuit may include both allocation circuit 140 and scheduler 150.

As further shown in FIG. 1, scheduler 150 includes a symmetric execution port scheduler 155 (also referred to herein as a “symmetric scheduler”). Symmetric scheduler 155 may be configured to schedule a single pop for execution on symmetric execution ports when the micro-lockstep mechanism is enabled for the pop. To this end, symmetric scheduler 155 may be configured to identify multiple identical execution ports for this redundant execution and cause the same set of source operands to be provided to these symmetric execution ports. Scheduler 150 couples to an execution unit 160 and a register file 180.

As shown, execution unit 160 includes a plurality of execution ports 165_{0-N}. Understand that within execution unit 160 many different types of execution circuits, including integer execution circuits, floating point execution circuits and vector execution circuits, may be present, each having at least one execution port. These execution circuits may include arithmetic logic units (ALUs), address generation units (AGUs), among other types of execution units. With respect to the micro-lockstep mechanism to be applied to vector instructions as described herein, a vector or other SIMD execution unit may include vector ALUs that may be configured to operate on different vector widths, e.g., 128, 256 and 512 bits.

When symmetric execution port scheduler 155 identifies a given vector pop for redundant execution, a set of one or more source operands may be provided to symmetric execution ports 165 (e.g., execution ports 165_{0,1}) for redundant execution of the pop. In turn, the results may be provided to a writeback unit 170. In embodiments, writeback unit 170 may include a checker circuit 175 that is configured to check the multiple results of the redundant execution. When checker circuit 175 determines that the results match, a given one of these two results (e.g., obtained from a first execution port of the symmetric execution ports) may be provided to a register file 180. If instead checker circuit 175 identifies an error, an error signal may be sent to an error handling circuit 190. Depending upon implementation, when such error is identified, the result may or may not also be written back to register file 180. In embodiments, error handling circuit 190 may be configured with a machine check architecture and may perform appropriate error handling in response to the error signal.

As further illustrated in FIG. 1, processor 100 also includes a configuration circuit 195. In embodiments, configuration circuit 195 may configure various circuitry of processor 100. Relevant to the micro-lockstep mechanism described herein, depending upon programming of a lockstep model specific register (MSR) 196, appropriate configuring of various components including lockstep selection circuit 145, symmetric execution port scheduler 155, and checker circuit 175 may occur (such as shown with the representative dashed line from MSR 196 to lockstep selection circuit 145). Understand while shown at this high level in the embodiment of FIG. 1, many variations and alternatives are possible.

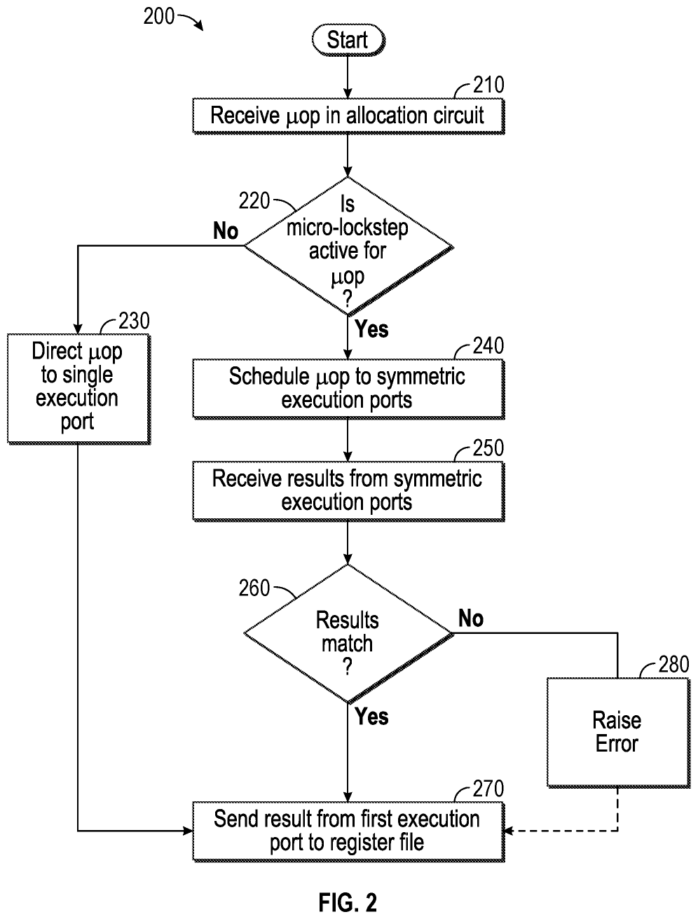

Referring now to FIG. 2, shown is a flow diagram of a method in accordance with an embodiment. As shown in FIG. 2, method 200 is a method for performing micro-lockstep operation, and may be implemented using various hardware circuitry of a processor core, alone or in combination with firmware and/or software. As illustrated, method 200 begins by receiving a pop in an allocation circuit (block 210). At diamond 220 it may be determined whether micro-lockstep operation is active (enabled) for this pop. In an embodiment, this determination may be based at least in part on the type of pop and programming mode. For example, a user may configure a processor to perform micro-lockstep operation only for certain instruction types, such as vector instructions. Further, the user may configure the micro-lockstep operation to be performed only for a given portion of such instructions, to reduce a performance penalty. This portion of the instructions may be according to a given duty cycle, on-off period or percentage. Thus, based at least in part on instruction type and programming, the determination at diamond 220 proceeds.

If it is determined that the micro-lockstep mechanism is not to be applied to this pop, control passes to block 230 where the pop may be directed, by a scheduler, to a single execution port. After execution on this single execution port, the result may be sent to a register file (block 270), via a writeback unit.

Still with reference to FIG. 2, if at diamond 220 it is instead determined that micro-lockstep operation is active, control passes to block 240 where the scheduler may schedule the pop to symmetric execution ports. Accordingly, the pop may execute concurrently on these two separate execution ports having identical circuitry. Control next passes to block 250 where a writeback unit may receive the results from the symmetric execution ports and, via an included checker circuit, determine whether the results match.

If it is determined (at diamond 260) that the results match, the result from one of the execution ports (namely a first execution port) may be sent to the register file (block 270). If instead the results do not match, an error may be raised (block 280). In this error condition, depending upon implementation, the result may optionally also be sent to the register file, as shown with the dashed line extending from block 280 to block 270. Understand while shown at this high level in the embodiment of FIG. 2, many variations and alternatives are possible.

As discussed above, a micro-lockstep mechanism may be configured to be programmably and dynamically enabled or disabled on a fine-grained basis, to provide a desired tradeoff between performance degradation and checking rigorousness. As discussed above, depending upon implementation, the mechanism may be applied to all instructions or pops, or only instructions/pops of a given type, such as vector-based instruction/pops. Further the mechanism may be wholly disabled or enabled, or may be applied on a user-configurable basis (with respect to a user-controlled ratio).

To this end, a user, via user-level software, may control a tradeoff between silent data error protection provided by the lockstep mechanism and performance loss via programming of an MSR, referred to as a lockstep MSR.

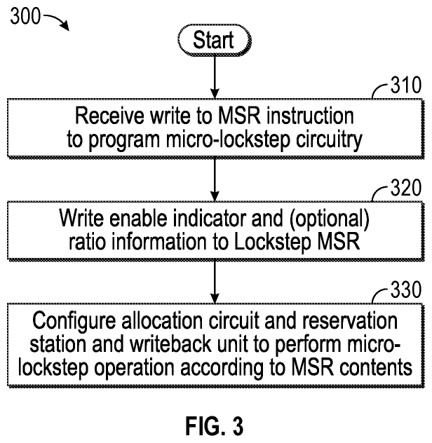

Referring now to FIG. 3, shown is a flow diagram of a method in accordance with another embodiment. As shown in FIG. 3, method 300 is a method for configuring micro-lockstep operation, and may be implemented using various hardware circuitry of a processor core, alone or in combination with firmware and/or software.

As illustrated, method 300 begins by receiving a write instruction (block 310). More specifically, this instruction may be a write instruction to an MSR to program the micro-lockstep circuitry. In response to this write instruction, data of the instruction may be written to the lockstep MSR. In one or more embodiments, the lockstep MSR may include multiple fields, including an enable field that stores an enable indicator and a ratio field that stores ratio information. The enable indicator, when set, indicates that the micro-lockstep circuitry is to be enabled. In turn, the ratio information stored in the ratio field may indicate a checking ratio. In one particular embodiment, this checking ratio may enable a tradeoff between SDE protection and performance.

Still referring to FIG. 3, control next passes to block 330 where various micro-lockstep circuitry as may be present in an allocation circuit, reservation station and writeback unit, may be configured to perform micro-lockstep operation according to the MSR contents. In this way, the various circuitry may be configured such that selected pops are redundantly executed as described herein. Understand while shown at this high level in the embodiment of FIG. 3, many variations and alternatives are possible.

In one embodiment, the MSR may have a first field to store enable information and programmable control. In such embodiment, this field may be used to store a given one of the following settings: ‘00 (disabled); ‘01 (continuous checking full lockstep execution on vector execution circuitry); and 11 (lockstep operation according to a given checking ratio). The MSR may further have a second field to store ratio information. In an embodiment various ratios, such as 1/1, 1/2, 1/4, 1/8, 1/16, 1/32, may be effected based on a given ratio value (where the denominator may be the ratio value).

In different implementations, there may be various checking options. As two examples, a checking ratio may indicate that for every pop that is checked, there are N pops that are not checked; or a checking ratio may indicate that for every X cycle window in which all pops are checked, there is window of (X times N) cycles in which no redundant execution occurs. Choosing between these two possible options can be done a priori or by user control, if both options are implemented. For this second implementation, during a checking pulse period of X cycles, scheduler circuitry may sequester an additional symmetric execution port for checking purposes, where this execution port is presented with the exact same source operands and opcode of a reference execution port to be checked. Since the same pop starts its execution at the same time on two execution ports in parallel, the results are compared to match during a writeback stage. Only one execution port writes back its result to the register file (or bypass logic), while the other execution port (which served as checker) discards its result after comparison.

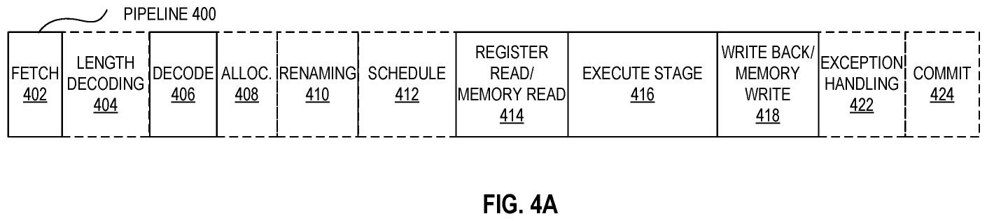

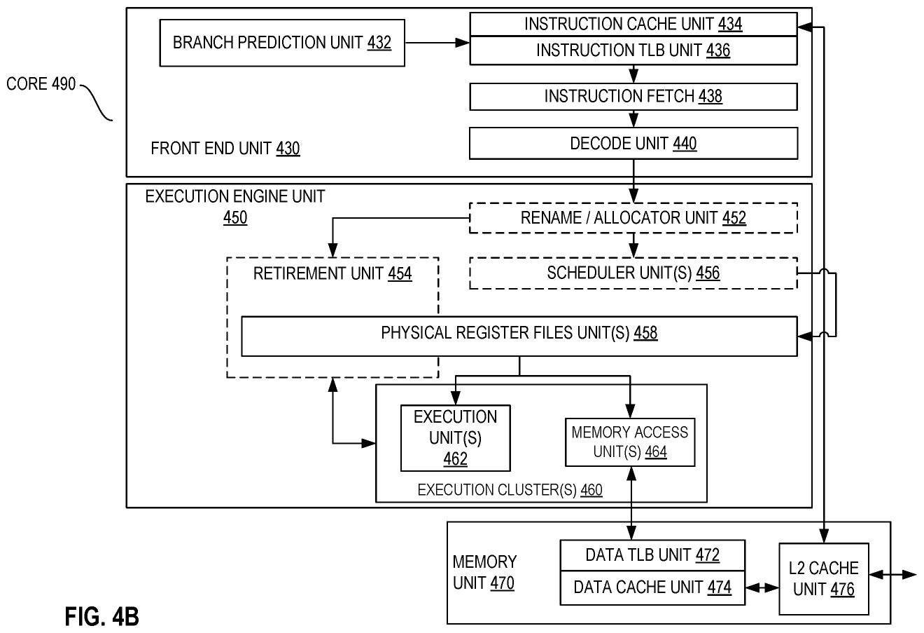

Embodiments may be implemented in many different processor configurations. FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A and 4B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424. Note that as described herein, in a given embodiment a core may include multiple processing pipelines such as pipeline 400.

FIG. 4B shows processor core 490 including a front end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front end unit 430 includes a branch prediction unit 432 coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The rename/allocator unit 452 may be configured to identify when a micro-lockstep mode is to be enabled for select instructions in an instruction stream, as described herein. The scheduler unit(s) 456 represents any number of different schedulers, including reservations stations, central instruction window, etc., and may be configured to schedule select pops to symmetric execution ports, as described herein. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a write mask registers unit, and a scalar registers unit. These register units may provide architectural vector registers, vector mask registers, and general purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 (including micro-lockstep operation as described herein) and renaming stage 410; 4) the scheduler unit(s) 456 performs the schedule stage 412 (including scheduling a single pop to multiple execution ports as described herein); 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

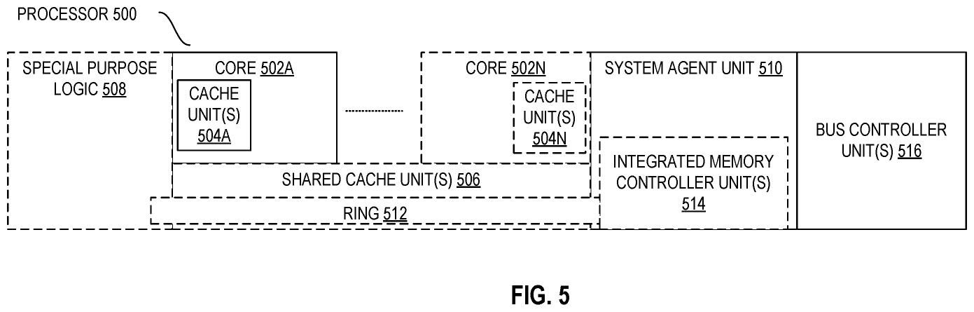

FIG. 5 is a block diagram of a processor 500 that may have more than one core, may have an integrated memory controller, and may have integrated graphics and micro-lockstep circuitry according to embodiments of the invention. The solid lined boxes in FIG. 5 illustrate a processor 500 with a single core 502A, a system agent 510, a set of one or more bus controller units 516, while the optional addition of the dashed lined boxes illustrates an alternative processor 500 with multiple cores 502A-N, a set of one or more integrated memory controller unit(s) in the system agent unit 910, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache units 504A-N within the cores, a set or one or more shared cache units 506, and external memory (not shown) coupled to the set of integrated memory controller units 514. The set of shared cache units 506 may include one or more mid-level caches, such as level 2 (L2), level 3 (L3), level 4 (L4), or other levels of cache, a last level cache (LLC), and/or combinations thereof. While in one embodiment a ring based interconnect unit 512 interconnects the special purpose logic 508, the set of shared cache units 506, and the system agent unit 510/integrated memory controller unit(s) 514, alternative embodiments may use any number of well-known techniques for interconnecting such units. In one embodiment, coherency is maintained between one or more cache units 506 and cores 502 A-N.

The system agent unit 510 includes those components coordinating and operating cores 502A-N. The system agent unit 510 may include for example a power control unit (PCU) and a display unit. The PCU may be or include logic and components needed for regulating the power state of the cores 502A-N and the special purpose logic 508. The display unit is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set.

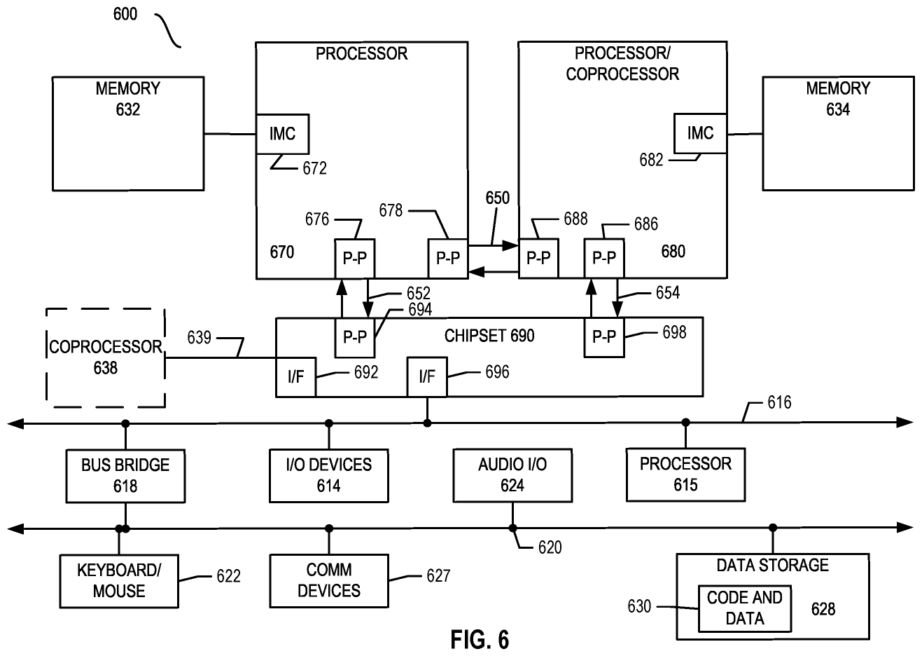

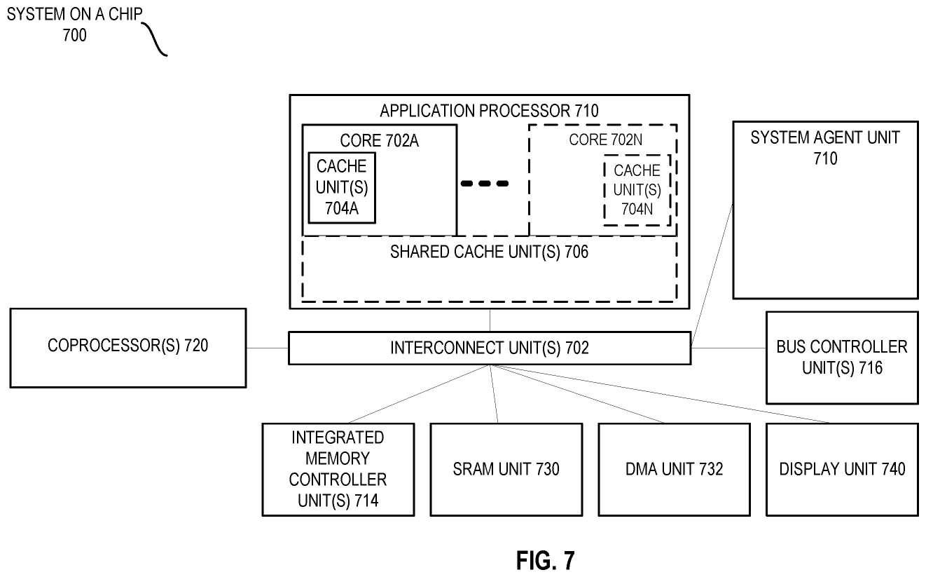

FIGS. 6-7 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a first more specific exemplary system 600 in accordance with an embodiment of the present invention. As shown in FIG. 6, multiprocessor system 600 is a point-to-point interconnect system, and includes a first processor 670 and a second processor 680 coupled via a point-to-point interconnect 650. Each of processors 670 and 680 may be some version of the processor 500.

Processors 670 and 680 are shown including integrated memory controller (IMC) units 672 and 682, respectively. Processor 670 also includes as part of its bus controller units point-to-point (P-P) interfaces 676 and 678; similarly, second processor 680 includes P-P interfaces 686 and 688. Processors 670, 680 may exchange information via a point-to-point (P-P) interface 650 using P-P interface circuits 678, 688. As shown in FIG. 6, IMCs 672 and 682 couple the processors to respective memories, namely a memory 632 and a memory 634, which may be portions of main memory locally attached to the respective processors.

Processors 670, 680 may each exchange information with a chipset 690 via individual P-P interfaces 652, 654 using point to point interface circuits 676, 694, 686, 698. Chipset 690 may optionally exchange information with the coprocessor 638 via a high-performance interface 639. In one embodiment, the coprocessor 638 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

As shown in FIG. 6, various I/O devices 614 may be coupled to first bus 616, along with a bus bridge 618 which couples first bus 616 to a second bus 620. In one embodiment, one or more additional processor(s) 615, such as coprocessors, high-throughput MIC processors, GPGPU's, accelerators (such as, e.g., graphics accelerators or digital signal processing (DSP) units), field programmable gate arrays, or any other processor, are coupled to first bus 616. In one embodiment, second bus 620 may be a low pin count (LPC) bus. Various devices may be coupled to a second bus 620 including, for example, a keyboard and/or mouse 622, communication devices 627 and a storage unit 628 such as a disk drive or other mass storage device which may include instructions/code and data 630, in one embodiment. Further, an audio I/O 624 may be coupled to the second bus 620. Note that other architectures are possible. For example, instead of the point-to-point architecture of FIG. 6, a system may implement a multi-drop bus or other such architecture.

Referring now to FIG. 7, shown is a block diagram of a SoC 700 in accordance with an embodiment of the present invention. Dashed lined boxes are optional features on more advanced SoCs. In FIG. 7, an interconnect unit(s) 702 is coupled to: an application processor 710 which includes a set of one or more cores 702A-N (including constituent cache units 704A-N) and shared cache unit(s) 706; a system agent unit 710; a bus controller unit(s) 716; an integrated memory controller unit(s) 714; a set or one or more coprocessors 720 which may include integrated graphics logic, an image processor, an audio processor, and a video processor; a static random access memory (SRAM) unit 730; a direct memory access (DMA) unit 732; and a display unit 740 for coupling to one or more external displays. In one embodiment, the coprocessor(s) 720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 630 illustrated in FIG. 6, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

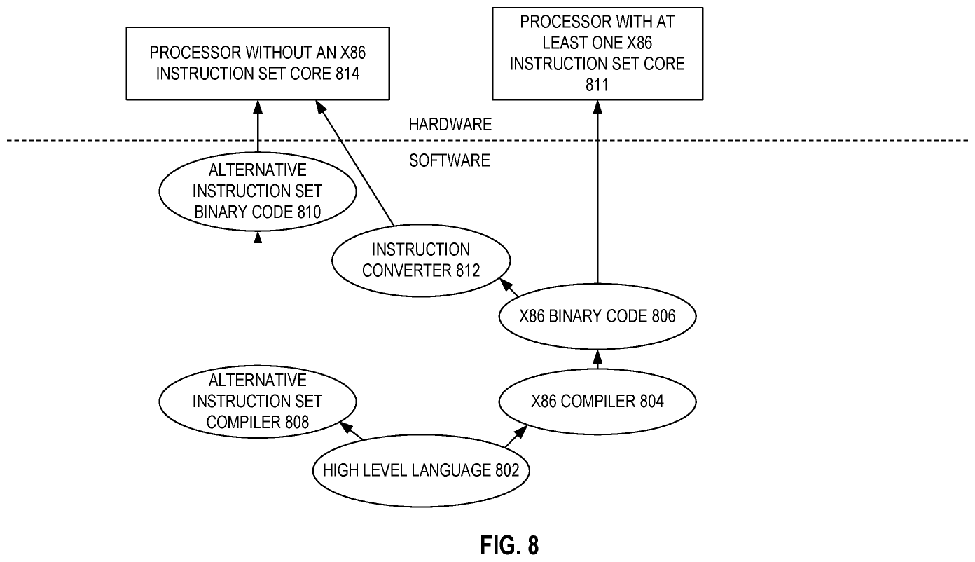

FIG. 8 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 8 shows a program in a high level language 802 may be compiled using an x86 compiler 804 to generate x86 binary code 806 that may be natively executed by a processor with at least one x86 instruction set core 816. The processor with at least one x86 instruction set core 816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 804 represents a compiler that is operable to generate x86 binary code 806 (e.g., object code) that can, with or without additional linkage processing, be executed on the processor with at least one x86 instruction set core 816. Similarly, FIG. 8 shows the program in the high level language 802 may be compiled using an alternative instruction set compiler 808 to generate alternative instruction set binary code 810 that may be natively executed by a processor without at least one x86 instruction set core 814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 812 is used to convert the x86 binary code 806 into code that may be natively executed by the processor without an x86 instruction set core 814. This converted code is not likely to be the same as the alternative instruction set binary code 810 because an instruction converter capable of this is difficult to make; however, the converted code will accomplish the general operation and be made up of instructions from the alternative instruction set. Thus, the instruction converter 812 represents software, firmware, hardware, or a combination thereof that, through emulation, simulation or any other process, allows a processor or other electronic device that does not have an x86 instruction set processor or core to execute the x86 binary code 806.

The following examples pertain to further embodiments.

In one example, an apparatus comprises: an instruction fetch circuit to fetch instructions; a decode circuit coupled to the instruction fetch circuit to decode the fetched instructions into pops; a scheduler coupled to the decode circuit to schedule the pops for execution; and an execution circuit coupled to the scheduler. The execution circuit comprises a plurality of execution ports to execute the pops, where the scheduler is to: schedule at least some pops of a first type for redundant execution on symmetric execution ports of the plurality of execution ports; and schedule pops of a second type for non-redundant execution on a single execution port of the plurality of execution ports.

In an example, the apparatus further comprises a checker circuit coupled to the execution circuit, wherein the checker circuit is to determine whether a first result of a first pop of the first type generated by a first symmetric execution port matches a second result of the first pop of the first type generated by a second symmetric execution port.

In an example, the checker circuit is to raise an error if the first result does not match the second result.

In an example, the apparatus further comprises a writeback circuit to write the first result to a register file.

In an example, the scheduler is to schedule the at least some pops of the first type for the redundant execution during a first time window and to schedule a second portion of pops of the first type for non-redundant execution during a second time window.

In an example, the scheduler is to schedule the at least some pops of the first type comprising a first set of pops of the first type for the redundant execution and to schedule a second set of pops of the first type for non-redundant execution based at least in part on user control.

In an example, the apparatus further comprises a MSR to store information regarding the user control.

In an example, the MSR comprises a first field to store an enable indicator, when set, to cause the scheduler to schedule the at least some pops of the first type for the redundant execution.

In an example, the MSR comprises a second field to store ratio information, the ratio information to cause the scheduler to schedule the at least some pops of the first type for the redundant execution according to a ratio indicated by the ratio information.

In an example, the ratio information is to cause a tradeoff between performance and data error protection.

In an example, the at least some pops of the first type comprise vector pops.

In another example, a method comprises: receiving, in an allocation circuit of a processor, a pop of a first type; scheduling the pop of the first type to symmetric execution ports of the processor, based at least in part on user selection of the pop of the first type for redundant execution; and storing a first result of the redundant execution of the pop of the first type generated by a first symmetric execution port of the symmetric execution ports in a register file of the processor.

In an example, the method further comprises: determining whether the first result matches a second result of the redundant execution generated by a second symmetric execution port of the symmetric execution ports; and in response to the first result matching the second result, storing the first result in the register file.

In an example, the method further comprises: determining whether the first result matches a second result of the redundant execution generated by a second symmetric execution port of the symmetric execution ports; and in response to the first result not matching the second result, raising an error.

In an example, the method further comprises: receiving, in the allocation circuit of the processor, a second pop of a second type; scheduling the second pop of the second type to a single execution port of the processor; and storing a second result of execution of the second pop of the second type generated by the single execution port in the register file.

In an example, the method further comprises obtaining the user selection from a MSR of the processor, the MSR storing enable information and ratio information.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a processor comprising at least one core and at least one storage to store lockstep information and a system memory coupled to the processor. The at least one core comprises: an instruction fetch circuit to fetch instructions; a decode circuit coupled to the instruction fetch circuit to decode the fetched instructions into pops; a scheduler coupled to the decode circuit, the scheduler to schedule the pops for execution; and an execution circuit coupled to the scheduler, the execution circuit comprising a plurality of execution ports to execute the pops. The scheduler, based at least in part on the lockstep information, is to: schedule one or more pops of a first type for redundant execution on symmetric execution ports of the plurality of execution ports; and schedule pops of a second type for non-redundant execution on a single execution port of the plurality of execution ports.

In an example, the processor further comprises a MSR to store the lockstep information.

In an example, the MSR comprises: a first field to store an enable indicator, when set, to cause the scheduler to schedule the one or more pops of the first type for the redundant execution; and a second field to store ratio information, the ratio information to cause the scheduler to schedule the one or more pops of the first type for the redundant execution according to a ratio indicated by the ratio information.

In an example, in response to a write instruction, the processor is to store the lockstep information in the MSR, the lockstep information to indicate a user selection of a tradeoff between single data error protection and performance.

In another example, an apparatus comprises: instruction fetch means for fetching instructions; decoder means for decoding the fetched instructions into pops; scheduler means for scheduling the pops for execution; and execution means. The execution means comprises a plurality of execution means for executing the pops, where the scheduler means is to: schedule at least some pops of a first type for redundant execution on symmetric execution means of the plurality of execution means; and schedule pops of a second type for non-redundant execution on a single execution means of the plurality of execution means.

In an example, the apparatus further comprises a checker means for determining whether a first result of a first pop of the first type generated by a first symmetric execution means matches a second result of the first pop of the first type generated by a second symmetric execution means.

In an example, the checker means is to raise an error if the first result does not match the second result.

In an example, the apparatus further comprises a writeback means for writing the first result to a register file.

In an example, the scheduler means is to schedule the at least some pops of the first type for the redundant execution during a first time window and to schedule a second portion of pops of the first type for non-redundant execution during a second time window.

In an example, the scheduler means is to schedule the at least some pops of the first type comprising a first set of pops of the first type for the redundant execution and to schedule a second set of pops of the first type for non-redundant execution based at least in part on user control.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
an instruction fetch circuit to fetch instructions;
a decode circuit coupled to the instruction fetch circuit to decode the fetched instructions into micro-operations (pops);
a scheduler coupled to the decode circuit, the scheduler to schedule the pops for execution; and
an execution circuit coupled to the scheduler, the execution circuit comprising a plurality of execution ports to execute the pops, wherein the scheduler is to:
schedule at least some pops of a first type for redundant execution on symmetric execution ports of the plurality of execution ports; and
schedule pops of a second type for non-redundant execution on a single execution port of the plurality of execution ports.

2. The apparatus of claim 1, further comprising a checker circuit coupled to the execution circuit, wherein the checker circuit is to determine whether a first result of a first pop of the first type generated by a first symmetric execution port matches a second result of the first pop of the first type generated by a second symmetric execution port.

3. The apparatus of claim 2, wherein the checker circuit is to raise an error if the first result does not match the second result.

4. The apparatus of claim 2, further comprising a writeback circuit to write the first result to a register file.

5. The apparatus of claim 1, wherein the scheduler is to schedule the at least some pops of the first type for the redundant execution during a first time window and to schedule a second portion of pops of the first type for non-redundant execution during a second time window.

6. The apparatus of claim 1, wherein the scheduler is to schedule the at least some pops of the first type comprising a first set of pops of the first type for the redundant execution and to schedule a second set of pops of the first type for non-redundant execution based at least in part on user control.

7. The apparatus of claim 6, further comprising a model specific register (MSR) to store information regarding the user control.

8. The apparatus of claim 7, wherein the MSR comprises a first field to store an enable indicator, when set, to cause the scheduler to schedule the at least some pops of the first type for the redundant execution.

9. The apparatus of claim 7, wherein the MSR comprises a second field to store ratio information, the ratio information to cause the scheduler to schedule the at least some pops of the first type for the redundant execution according to a ratio indicated by the ratio information.

10. The apparatus of claim 9, wherein the ratio information is to cause a tradeoff between performance and data error protection.

11. The apparatus of claim 1, wherein the at least some pops of the first type comprise vector pops.

12. A method comprising:
receiving, in an allocation circuit of a processor, a micro-operation (pop) of a first type;
scheduling the pop of the first type to symmetric execution ports of the processor, based at least in part on user selection of the pop of the first type for redundant execution; and
storing a first result of the redundant execution of the pop of the first type generated by a first symmetric execution port of the symmetric execution ports in a register file of the processor.

13. The method of claim 12, further comprising:
determining whether the first result matches a second result of the redundant execution generated by a second symmetric execution port of the symmetric execution ports; and
in response to the first result matching the second result, storing the first result in the register file.

14. The method of claim 12, further comprising:
determining whether the first result matches a second result of the redundant execution generated by a second symmetric execution port of the symmetric execution ports; and
in response to the first result not matching the second result, raising an error.

15. The method of claim 12, further comprising:
receiving, in the allocation circuit of the processor, a second pop of a second type;
scheduling the second pop of the second type to a single execution port of the processor; and
storing a second result of execution of the second pop of the second type generated by the single execution port in the register file.

16. The method of claim 12, further comprising obtaining the user selection from a model specific register (MSR) of the processor, the MSR storing enable information and ratio information.

17. A system comprising:
a processor comprising at least one core and at least one storage to store lockstep information, the at least one core comprising:
an instruction fetch circuit to fetch instructions;
a decode circuit coupled to the instruction fetch circuit to decode the fetched instructions into micro-operations (pops);
a scheduler coupled to the decode circuit, the scheduler to schedule the pops for execution; and
an execution circuit coupled to the scheduler, the execution circuit comprising a plurality of execution ports to execute the pops, wherein the scheduler, based at least in part on the lockstep information, is to:
schedule one or more pops of a first type for redundant execution on symmetric execution ports of the plurality of execution ports; and
schedule pops of a second type for non-redundant execution on a single execution port of the plurality of execution ports; and
a system memory coupled to the processor.

18. The system of claim 17, wherein the processor further comprises a model specific register (MSR) to store the lockstep information.

19. The system of claim 18, wherein the MSR comprises:
a first field to store an enable indicator, when set, to cause the scheduler to schedule the one or more pops of the first type for the redundant execution; and
a second field to store ratio information, the ratio information to cause the scheduler to schedule the one or more pops of the first type for the redundant execution according to a ratio indicated by the ratio information.

20. The system of claim 18, wherein in response to a write instruction, the processor is to store the lockstep information in the MSR, the lockstep information to indicate a user selection of a tradeoff between single data error protection and performance.
